(19) United States
(12) Patent Application Publication
(10) Pub. No.: US 2001/0013014 A1
(43) Pub. Date: Aug. 9, 2001

(54) Method for facilitating an on-line order

(76) Inventor: Koichi Fukumuro, Tokyo (JP)

Correspondence Address: ADAMS & WILKS, 31st Floor, 50 Broadway, New York, NY, 10004, US

(21) Appl. No.: 09/772,014

(22) Filed: Jan. 29, 2001

(30) Foreign Application Priority Data
Jan. 28, 2000 (JP) 2000-019911

(51) Int. Cl. G06F 17/60

(52) U.S. Cl. 705/26

(57) ABSTRACT

A method of facilitating an on-line order for a product that conforms to an orderer's image of the product, by using a part library in a server for storing a plurality of different styles for each of certain components of timepiece products. An orderer can select and combine desired ones of the component styles from the part library. In response to a connection between an orderer's computer and the server and the selection of a given product, a character entry page may be transmitted to the orderer to permit the orderer to enter character data used for decoration of a timepiece dial. A conceptual drawing of the finished product is generated and displayed on the orderer's computer based on the entered data.

### BACKGROUND OF THE INVENTION

1. Field of the Invention

The present invention relates to a method of facilitating the ordering of goods over a network and, more particularly, to a method of facilitating an on-line order that permits a consumer to specify the design or decoration of a finished product being ordered by selecting from various choices.

2. Description of the Related Art

There are currently various on-line applications providing for the ordering of goods over the Internet. Some such applications that have recently become available permit consumers to specify the design of a finished product by selecting the individual components of the product from parts libraries containing plural choices for each component. A consumer who wishes to place an order on-line can make selections from the plural choices to order a finished product comprising a combination of the different components selected from a corresponding parts library on a homepage or the like of the product offeror. For example, on the homepage of a company which offers customizable timepieces for sale on-line, a consumer can order a timepiece having features desired by the consumer by selecting desired timepiece components from a library of dials, hour hands and second hands of various designs. On other homepages, one can order a customized timepiece having a dial imprinted with characters such as text or other visual indicia by inputting the desired characters into a column or box of a fill-in form for example. In accordance with a first known application which is a homepage offering watch products (e.g., http://www.artpolis.co.jp/ maintained by SII Trading Inc. of Japan), a consumer can customize the dial design of a timepiece such as a wristwatch by selecting a preferred one of a plurality of possible character decoration positions on the watch dial, the decoration positions being displayed on a fill-in form rendered on the viewing screen of the consumer's personal computer terminal. After selecting the desired character decoration position, the consumer then enters characters into a given entry column or box provided in the same or different fill-in form. In this manner, the consumer can order a customized wristwatch decorated in a desired manner.

In a second on-line timepiece ordering application, the consumer can download a dial template file and create an image file according to the template. After creating the image file, the consumer sends an email with the completed image file attached to place an order for a timepiece having the desired dial.

In the first application, however, the characters entered by the consumer into a fill-in form on a web page are displayed independent of the selected character decoration position on the product. As a result, the consumer cannot confirm how the character decoration will appear on the actual product. The completed product may differ from that perceived by the consumer s imagination.

Unlike the first application, the second application permits the consumer to create an image having a character decoration. Thus, it is unlikely that the consumer's perceived image of the product decoration will differ from the actual product decoration. However, the consumer is shown only an image of the dial and cannot see an image of the entire product. As a result, the completed product may be different from an image in the consumer's mind. Furthermore, after the template file is downloaded, the consumer needs to process the image, which places a burden on the consumer.

### SUMMARY OF THE INVENTION

In view of the foregoing drawbacks, it is an object of the present invention to provide a method for facilitating the ordering of a product on-line which allows a consumer to select components of the product from a plurality of available components.

Another object of the present invention is to provide a method for facilitating the ordering of products on-line which allows a consumer to select components of the product from a plurality of available components, and which allows the consumer to specify product decoration.

Yet another object of the present invention is to provide a method of the foregoing type which produces an image of a product based on the selected components and product decoration.

In order to achieve the foregoing objects and others which will become more apparent from a reading of the disclosure herein, the present invention provides a method of facilitating the on-line ordering of a product by using a server having stored therein a part library for each of a plurality of components of the product, each component having a plurality of pre-stored styles. When a connection is established between the server and a computer operated by a consumer, the part library is rendered on the consumer's computer and permits the consumer to select a style for each component which will be combined to produce the finished product. At least one of the parts preferably permits the consumer to specify on-line alphanumerical and/or image data to be applied thereto for decoration of the part. A conceptual drawing of the finished product based on the combination of selected styles and the alphanumerical and/or image data is rendered on the consumer's computer at the request of the consumer, thus urging the consumer to place a formal order.

Preferably, the alphanumerical data permits selection of colors, tones, fonts, font sizes, and/or font colors.

Preferably, the product is a timepiece, and the part decorated with the alphanumerical and/or image data supplied by the consumer is the dial of the timepiece.

In accordance with the present invention, when a consumer makes a request for a product, a conceptual drawing of the finished product is rendered on-line for the consumer to illustrate the selected style of components of the product and the appearance of alphanumerical and/or image data used for decoration of a part selected on-line by the consumer to permit the consumer to order a product that matches up to his or her image.

### BRIEF DESCRIPTION OF THE DRAWINGS

FIG. 1 is a block diagram illustrating a system for and method of facilitating an on-line order in accordance with one embodiment of the present invention;

FIG. 2 is a view of a product select page rendered on a consumer's computer terminal to permit selection by the consumer of a given product in the embodiment of the invention shown in FIG. 1;

FIG. 3 is a view of a part select page rendered on a consumer's computer terminal to permit selection by the consumer of styles of various components of a selected product in the embodiment of the invention shown in FIG. 1;

FIG. 4 is a view of a character entry page rendered on a consumer's computer terminal to permit the consumer to enter character data such as text at desired locations on a component of the selected product in the embodiment of the invention shown in FIG. 1;

FIG. 5 is a view of a preview page showing a conceptual drawing of the selected product having the selected component styles and text entered by the consumer in the embodiment of the invention shown in FIG. 1;

FIG. 6 is a view of a completion page showing a conceptual drawing of the finished product selected by the consumer and having the selected component styles and text entered by the consumer in the embodiment of the invention shown in FIG. 1;

FIG. 7 is a flowchart illustrating operation of the embodiment of the invention shown in FIG. 1; and

FIG. 8 is a view of an image entry page permitting the consumer to enter image data onto a component of the product in a variation of the embodiment of the invention shown in FIG. 1.

### DETAILED DESCRIPTION OF THE PREFERRED EMBODIMENTS

The teachings of the present invention are applicable to many different types of networks, including computer networks, and may also be used, for instance, in conjunction with direct on-line connections to databases. As will be appreciated by those of ordinary skill in the art, while the following discussion sets forth various preferred implementations of the method and system of the present invention, these implementations are not intended to be restrictive of the appended claims, nor are they intended to imply that the claimed invention has limited applicability to one type of network such as the Internet, or that the inventive system and method is limited to a network of computers such as personal computers. In this regard, the teachings of the present invention are equally applicable for use in devices such as televisions (e.g., so-called interactive TV), telephones, cellular and satellite communications devices and the like, handheld computers, wristwatch-type computing devices, and any other type of data transmission and receiving device capable of achieving connectivity with a server. Accordingly, the present invention applies to any type of network, including local and wide area networks, private networks, on-line subscription services, on-line database services, public networks including the Internet and the World Wide Web, television networks, satellite networks, and wireless networks. While the principles underlying the Internet and the World Wide Web are described in connection with various aspects of the present invention, this discussion is provided for descriptive purposes only and is not intended to strictly limit the broadly claimed methods and systems of the present invention. Although the present invention may be practiced using both public and private networks, public networks are particularly well suited for use in connection with the present invention. For this reason, implementation of the present invention will be discussed in detail in connection with the Internet and the World Wide Web. This discussion is equally applicable to any network whether based upon the client-server model or another model capable of achieving the functionality described herein.

As will be further appreciated by those of ordinary skill in the art, as used herein, as used herein the term “orderer” refers to a physical person who is ordering a product and the term “consumer” refers not only to a physical person or other entity who wishes to purchase a product over a network, but to a client computer (or machine) on a network, or to a process, such as a Web browser, which runs on a client computer in order to facilitate network connectivity and communications. Thus, for example, the term “consumer” is used to broadly refer to one or more persons that use a particular machine or to the machine itself. As used herein, a “server” is a computer on a network which is used to serve information to an orderer or consumer on the same network, and to the entity responsible for maintaining the server computer.

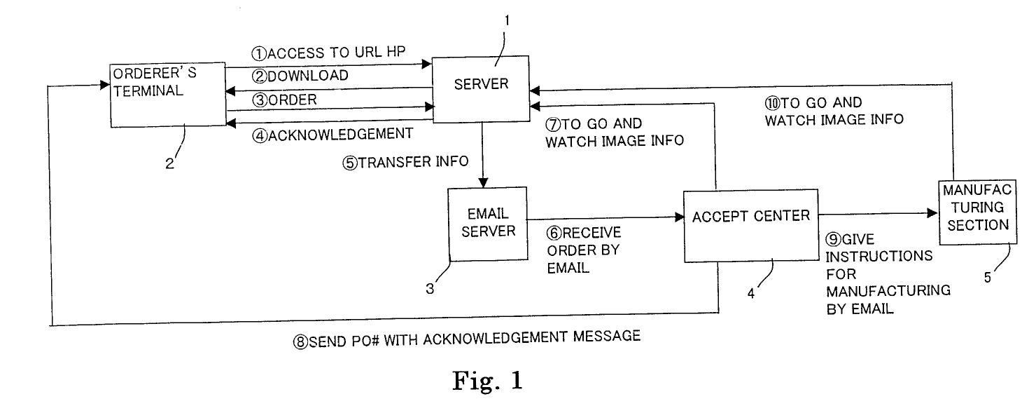

FIG. 1 illustrates a known computer network based on the client-server model, such as the Internet. The network comprises one or more servers 1 which are accessible by consumer units (identified in the drawing as orderer's terminals) 2, such as personal computers, which, in the case of the Internet, is provided through a private Internet access provider or an on-line service provider (such as America On-Line, Prodigy, CompuServe, the Microsoft Network, and the like). Each of the orderer's terminals 2 may run a “Web browser”, which is a known software tool used to access the World Wide Web via a connection obtained through an access provider. The server 1 allows access to various network resources. In the Internet, for example, a Web server 1 allows access to so-called “Web sites” which comprise resources in various different formats. A location of a resource on the server 1 is identified by a so-called Uniform Resource Locator, or URL.

The “World Wide Web” (“Web”) is that collection of servers on the Internet that utilize the Hypertext Transfer Protocol (HTTP). HTTP is a known application protocol that provides users access to resources (which can be information in different formats such as text, graphics, images, sound, video, Hypertext Markup Language (“HTML”), etc., as well as programs. HTML is a standard page description language which provides basic document formatting and allows the developer to specify “links” to other servers and files. Links are specified via a Uniform Resource Locator or “URL”. Upon specification of a link, the client makes a TCP/IP request to the server and receives information that was specified in that URL (for example, another Web page that was formatted according to HTML) in return. The information returned may be generated in whole or in part by a program that executes on the server. Such programs are typically known as CGI (Common-Gateway-Interface) scripts and can be written using known programming languages or methods that the server supports, such as PERL or C++. A typical Web page is an HTML document with text, links that a user may activate (e.g. “click on”), as well as embedded URLs pointing to resources (such as images, video or sound) that the consumer unit must fetch to fully render the Web Page in a browser. These resources may not be located on the same server that the HTML document was sent from. Furthermore, HTTP allows for the transmission of certain information from the consumer unit to a server. This information can be embedded within the URL, can be contained in the HTTP header fields, or can be posted directly to the server using known HTTP methods.

FIG. 1 illustrates a system and method of facilitating on-line orders in accordance with a first embodiment the present invention comprising a system and method of facilitating an on-line order for a timepiece over the Internet. In the figure, a server 1 comprises a web server connected with the Internet. The server 1 permits access thereto via the Internet from a consumer unit (orderer's terminal) 2 having a web browser installed therein. When accessed by an orderer's terminal 2 by the transmission of a specific URL in the manner described above, the server 1 transmits to the orderer's terminal a web page formatted in the manner described above. The web page permits the consumer to make various selections and to proceed to other web pages offered by the server 1. These web pages comprise Product Select Pages permitting the user to select a desired product, Part Select Pages permitting the user to select parts (e.g., a dial, a hour hand, and a minute hand) for the selected product, a Character Entry Page for urging the consumer to enter character or image data for decoration on the timepiece dial, a Preview Page for displaying a conceptual drawing of the product, and an Ordering Page permitting the user to order the product. As noted above, the server 1 is accessed by the orderer's terminal 2 over the Internet by use of a Uniform Resource Locator (URL) using the well known HTTP protocol. In response to receipt of the URL containing indicia identifying the location of the consumer terminal 2, the server transmits a specified web page to the orderer's terminal to initiate a product specifying and ordering transaction. The server 1 stores the web pages as HTML files that offer pages for sale of products as described above and image files used in the pages. The HTML files that display the pages are written in a programming language that permits various kinds of processing to be performed in response to entries into selection and entry columns or boxes (described later). When an order from the order's terminal 2 is accepted by the server, the server 1 stores order content data including data pertaining to the product selected by the consumer, parts selected by the consumer, character and/or image data entered by the consumer, and data about the consumer. The server 1 transfers the order content data to a mail server 3, which in turn sends an email confirmation to the consumer according to the contents of the order.

The email server 3 also sends the email describing the contents of the order to an order accept center 4 that puts together orders received from consumers.

An individual in charge or an automated process at the order accept center 4 checks the contents of the order and confirms the image of the product that is ordered via the server 1. The individual or automated process then sends an email confirmation to the consumer and sends an email indicating the contents of the order to a manufacturing section 5 to instruct the manufacturing section 5 to manufacture the product. On receiving the email, an individual or automated process at the manufacturing section 5 checks the image of the product ordered via the server 1, as well as the contents of the order. The product is then manufactured according to the contents of the order.

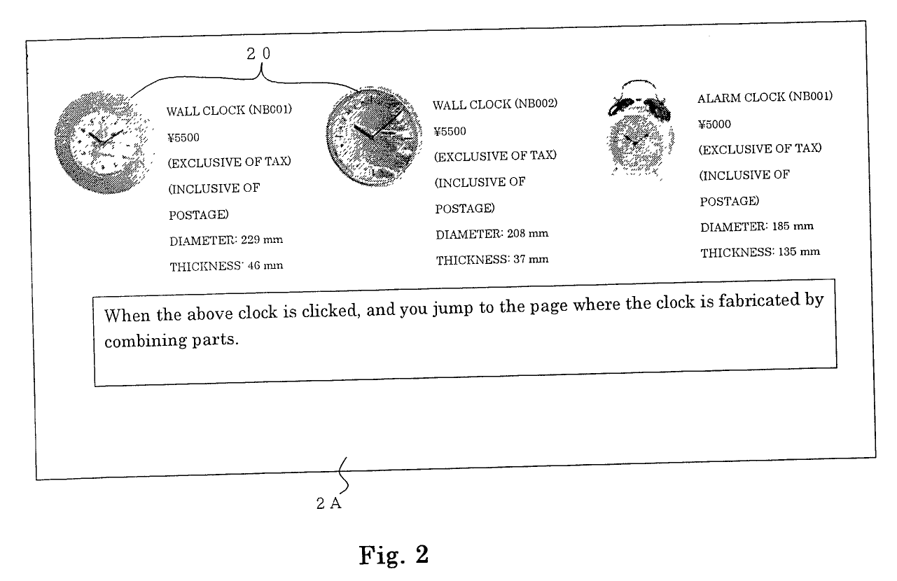

Then, the configurations of the Product Select Pages, Part Select Pages, the Character Entry Page, the Preview Page, and a Completion Page are described in detail with reference to FIGS. 2 to 6.

A Product Select Page 2A is shown in FIG. 2. This web page is transmitted from the server 1 and rendered on the orderer's terminal 2 in response to a connection established between the server 1 and the orderer's terminal. The Product Select Page 2A may be the first page that is rendered on the orderer's terminal when the URL of the server 1 is entered by the consumer, or may be a page that is rendered when a link to the page is established by clicking on a link provided in another page. As illustrated, the Product Select Page 2A provides images 20 of commercial products that are available for sale, together with product descriptions and pricing information. The images 20 are linked by the use of embedded URLs to Part Select Pages corresponding to the individual products.

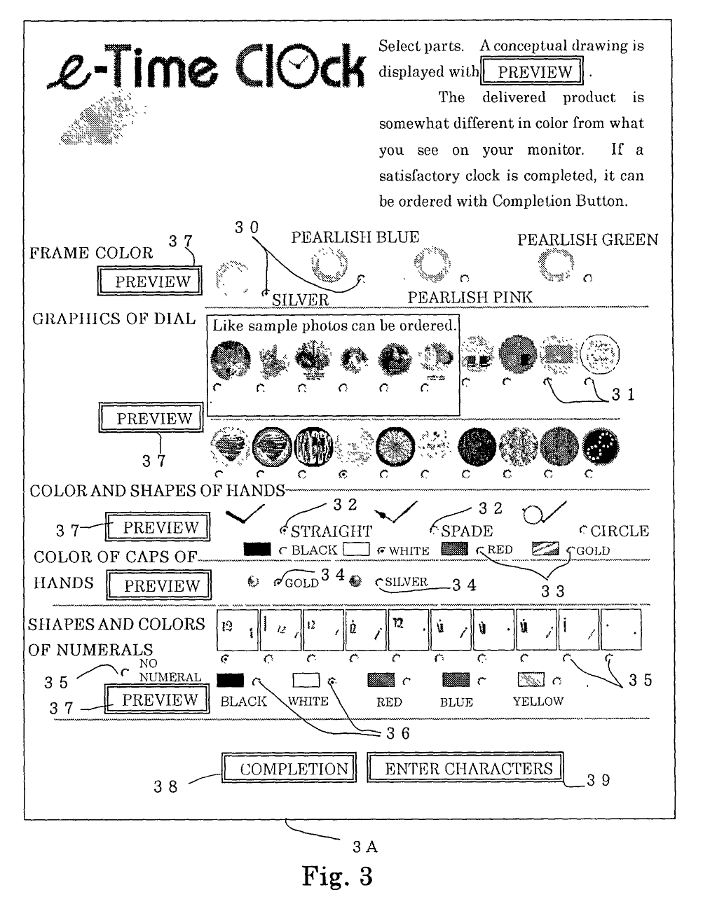

A Part Select Page 3A for a given product is transmitted from the server 1 to the orderer's terminal 2 when a given product 20 is selected. Each of the products 20 has a Part Select Page 3A associated therewith, and the particular Part Select Page 3A is selected based on the particular product 20 selected by the consumer. A Part Select Page 3A that is downloaded and rendered on the orderer's terminal when a product 20 is selected is shown in FIG. 3. The Part Select Page 3A contains frame color select columns or circles 30 for permitting the consumer to select the color of the frame of the selected clock. A given one of the fame colors is selected by clicking on or near a given one of the columns or circles 30 using an input device such as a mouse in a known manner. Dial graphics select columns or circles 31 are provided to permit the consumer to select the graphic design of the dial of the selected clock. Similarly, hand shape select columns or circles 32, hand color select columns or circles 33, hand cap select columns or circles 34, numerical font select columns or circles 35, and time-indicating numeral color select columns or circles 36 are provided to permit the consumer to select the shape and color of indicating hands, the color of caps on the indicating hands, and the font and color of time-indicating numerals provided on the dial. The select columns or circles are displayed alongside a corresponding part image to permit the consumer to select desired parts from the part library stored in the server 1.

When a Preview Button 37 is clicked, the server generates a conceptual image of the selected product containing the components selected by the consumer. The conceptual image may be created in any known manner, such as by storing an image file for each of the selectable designs and combining the images to produce a image of the overall product, or by storing images of clocks having every one of the potential combinations selectable by the consumer. The conceptual image is transmitted to the orderer's terminal and rendered as a Preview Page showing the conceptual drawing of the finished product to the consumer based on the selections of component designs made by the consumer. Thus, for instance, when the consumer has selected at least one of the frame color, dial graphics, hand shape and color, and numeral shape and color, and a Preview Button 37 appearing adjacent the given criteria is clicked on using the input device, the conceptual drawing of the clock containing the selected component is rendered on the orderer's terminal. In this manner, the consumer can view the clock design as each of the components is changed. In an alternative embodiment, a program containing image data is downloaded to the orderer's terminal along with one of the HTML pages for generating the conceptual image of the product containing the orderer's selections.

In a similar manner, when a Completion Button 38 is clicked on by the consumer using the input device a Completion Page showing a similar conceptual drawing is displayed.

A Character Entry Button 39 is provided on the Part Select Page 3A to permit the consumer to enter text or character data that will appear on the dial of the timepiece (or at another desired location). When the Character Entry Button 39 is clicked on by the consumer, the selected states of the select circles for each of the component designs is stored and a Character Entry Page 4A is transmitted from the server 1 for display on the orderer's terminal.

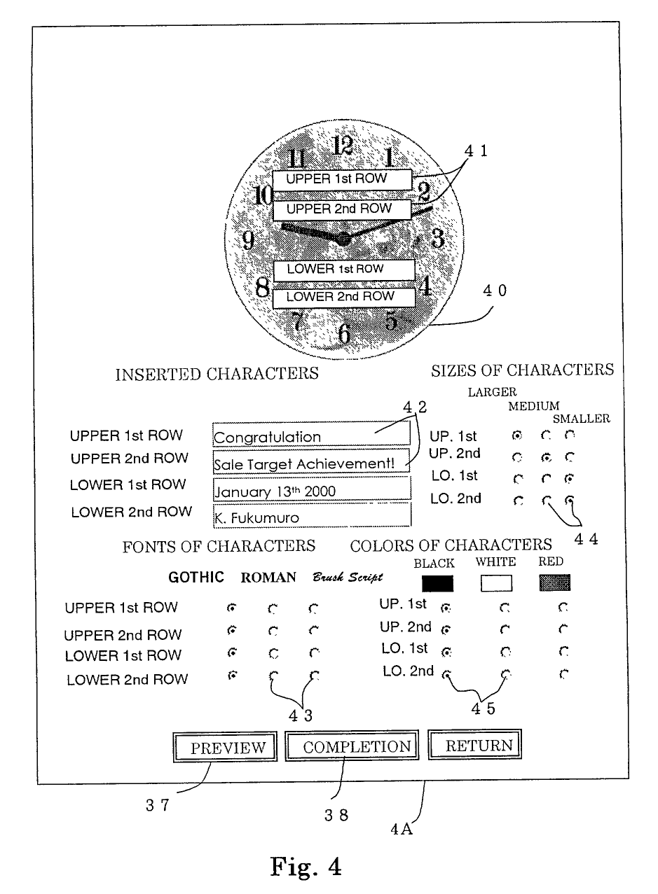

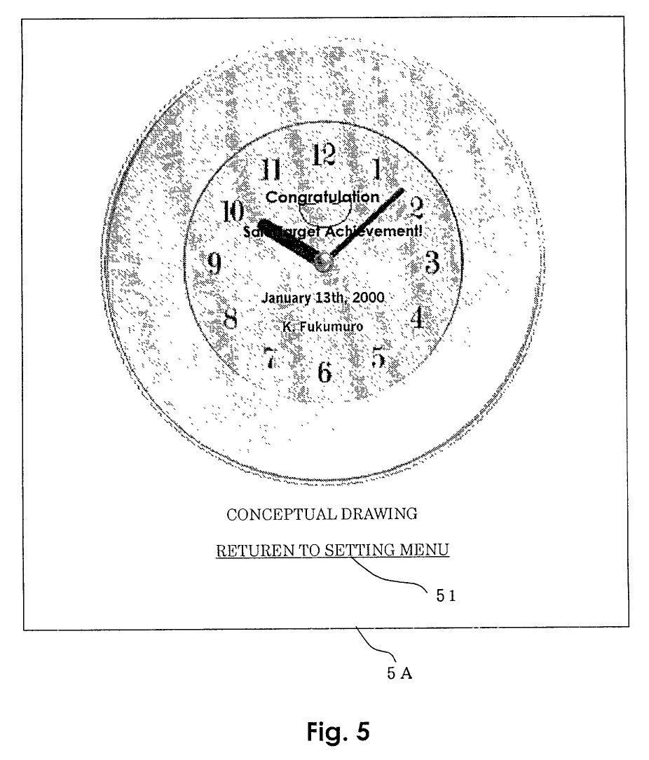

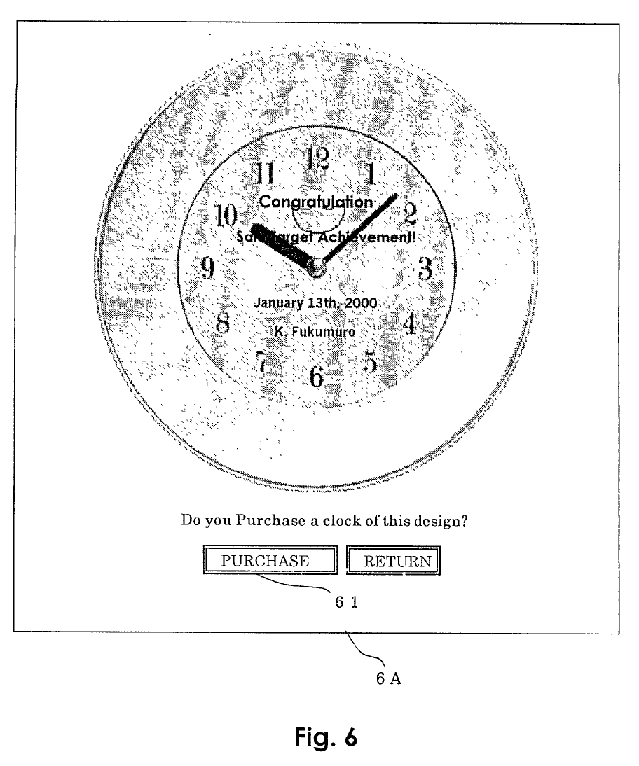

An exemplary Character Entry Page 4A is shown in FIG. 4 and contains an image of a dial 40 and frames or boxes 41 indicating character decoration positions on the dial 40. Character entry columns or bars 42 corresponding to the frames 41, font select columns or circles 43 for selecting character fonts, size select columns or circles 44 for selecting character sizes, and color select columns or circles 45 for selecting character colors are provided. The Preview Button 37 and the Completion Button 38 are provided also on the Character Entry Page. A conceptual drawing of the product is generated and displayed based on data pertaining to the parts selected by the orderer on the Character Entry Page and on the Part Select Page by clicking these buttons. When the Preview Button 37 is clicked, for example, a Preview Page 5A as shown in FIG. 5 is displayed on a display unit of the orderer's terminal. When the Completion Button 38 is clicked, a Completion Page 6A as shown in FIG. 6 is displayed. When a linking box 51 “Return to Setting Menu” contained in the Preview Page 5A is clicked, one can return to the Character Entry Page 4A, where the selected characters can be edited or a setting operation can be performed again. When the Completion Button 38 on the Character Entry Page 4A is clicked, the Completion Page 6A is displayed, and this page 6A has a link to “Purchase”. When the Purchase link is clicked, an HTML file of an ordering page (not shown) is sent from the server 1. Also, in any of the Part Select Page 3A and the Character Entry Page 4A, the Completion Button 38 is linked to the ordering page via the Completion Page 6A. The ordering page (not shown) contains columns or boxes for entering data about the orderer, including the orderer's residence address, the orderer's name, the orderer's contact telephone number, the orderer's shipping address (if different from the residence address), payment information, and a Send button for transmitting the entered data on the orderer to the server 1.

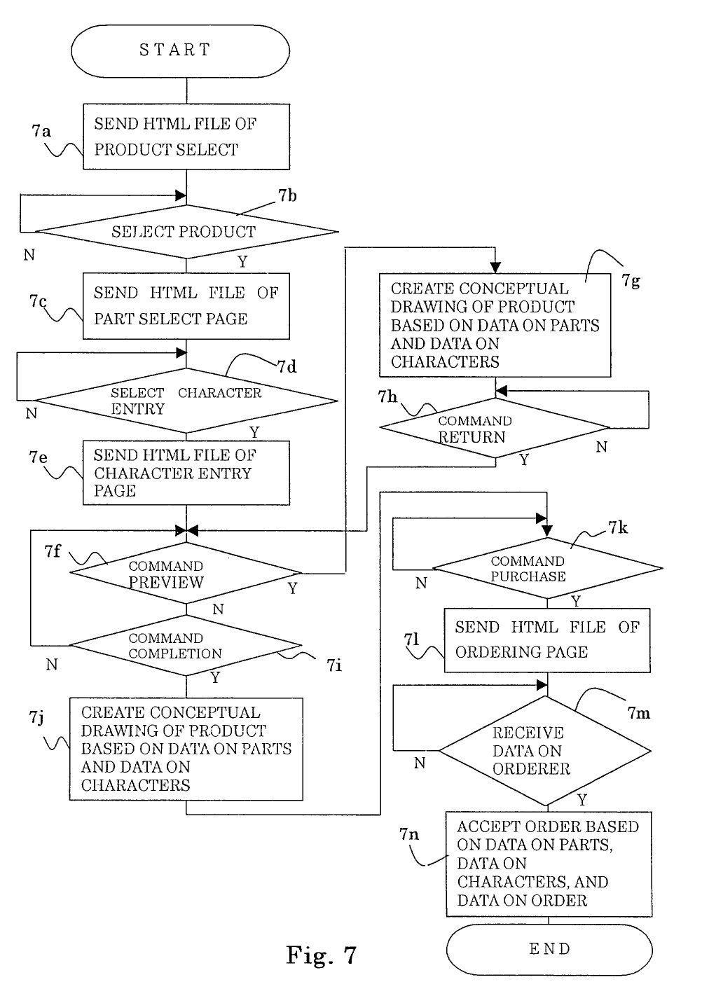

The operation of the present embodiment is described next with reference to the flowchart shown in FIG. 7.

When a connection is established between the orderer's terminal 2 and the server 1, the server 1 sends an HTML file containing the Product Select Page 2A to the orderer's terminal 2 (step 7a).

If any one of the images 20 on the Product Select Page 2A displayed on the orderer's terminal 2 is clicked (step 7b), the orderer's terminal 2 sends a request for sending of the HTML file of the Part Select Page to the server 1. In response to the request for sending, the server 1 sends the HTML file containing the Part Select Page 3A for the corresponding part (step 7c). The orderer selects a desired part from the menus of the select columns or circles 30-36 displayed on the terminal 2.

If the Character Entry Button 39 is clicked (step 7d), a request for sending of an HTML file of the Character Entry Page is sent to the server 1 by the orderer's terminal 2. In response to the request for sending, the server 1 sends the HTML file of the Character Entry Page 4A (step 7e).

The orderer refers to the frames 41 indicating the character decoration positions on the Character Entry Page 4A displayed on the terminal 2, enters arbitrary characters in the character entry columns or bars 42 corresponding to a desired character decoration position, and specifies desired ones of the font select columns or circles 43, the size select columns or circles 44, and the color select columns or circles 45.

If the Preview Button 37 is clicked (step 7f), a conceptual image of the product is generated. The part data and character data is synthesized based on the parts selected on the Part Select Page and the characters entered on the Character Entry Page, including their font, their size, and their colors, and the conceptual drawing of the finished product is created using this data (step 7g). In this manner, the Preview Page 5A containing the conceptual drawing of the finished product is displayed on the terminal 2. When the Preview Button 37 is clicked on the Part Select Page, operations for displaying a conceptual drawing of a finished product are similarly performed using data other than character data. The processing for creating the conceptual drawing of the finished product may be performed either by the server 1 or by the terminal 2. The selection may be made appropriately by giving an instruction for execution of the program on the side of the server 1 through the HTML file of the Character Entry Page 4A or writing a program that can be run on the terminal 2, such as by use of the Java programming language. Alternatively, images of all combinations of the products may be downloaded to the orderer's terminal and one of the images may be selected as the conceptual drawing based on the orderer's selections.

If the orderer returns to the Character Entry Page 4A (step 7h), and if the Completion Button 38 is then clicked (step 7i), the completion page 6A showing a conceptual diagram is displayed (step 7j). If the link to the ordering page (not shown) is clicked to place an order for purchase (step 7k), the server 1 sends the HTML file of the ordering page (step 7l). In this way, the ordering page is displayed. If the Completion Button 38 on the Part Select Page 3A is clicked, similar operations are performed.

On the ordering page, the user is urged to enter data about the orderer including his or her name, address and purchase information (e.g., credit card data) into the given entry columns or bars. If the Send Button is clicked, the data about the orderer is transmitted. If the data about the orderer is received (step 7m), the server 1 performs processing for acceptance of the order, and transmits the data about the orderer to the mail server, together with data about the product, data about the part, and data about the characters (step 7n). If the conceptual drawing is created not by the server 1 but by the terminal 2, the data about the product, the data about the part, and the data about the characters are stored in the server 1 until the processing for acceptance of the order is performed. The timing at which transmission is made may be set appropriately.

The email server 3 sends the contents of the order composed of data on the orderer, data on the part, and data on the characters to the orderer and to the person in charge of acceptance of orders. Also, the server 3 sends emails to the orderer a notice to the effect that the order has been received and is being processed.

Also, when the Completion Button 38 is clicked on the Part Select Page, similar operations are performed to display a conceptual drawing using data other than data about the characters.

As described thus far, in accordance with the present embodiment, images of parts corresponding to data about the parts and data about characters are synthesized on-line to create a conceptual drawing of the finished product. This conceptual drawing is offered to the orderer so the orderer can order a product on-line in a simpler fashion, whereby a product matching up to his or her image can be ordered.

In the embodiment described above, characters data is accepted. The invention is not limited to this. For instance, image data may alternately or additional be accepted by the server 1 for display on a timepiece. In this case, an image data accept column or box may be formed in the dial select box on the Part Select Page. A corresponding HTML file of the image entry page is stored in the server 1, or the orderer may transmit his or her own desired image to the server 1 to obtain a timepiece having that image appearing on the dial.

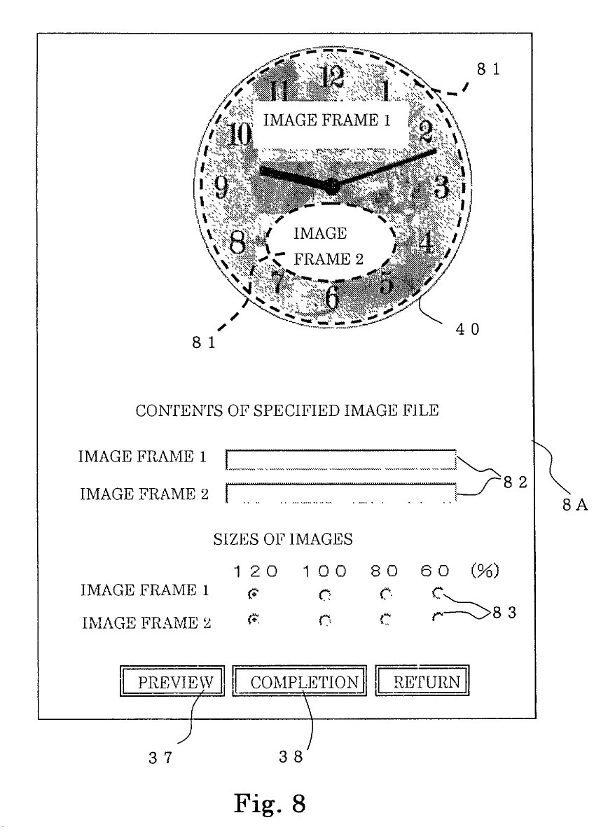

As shown in FIG. 8, an Image Entry Page 8A displays image frames 81 corresponding to the dial 40, in addition to the aforementioned Preview Button 37, and has an image entry column or bar 82 for specifying a file name and a path for the image file to be sent and an image size entry column or circle 83. These kinds of image data are sent by clicking the Preview Button 37. The server 1 converts the received image into a specified image size and trims it with a specified image frame. The image size is a factor of magnification or reduction with respect to the original image size. The trimming operation is performed while bringing the center of the received image to the center of the image frame 81, and the resulting image is put within the image frame 81. Note that the invention is not limited to this. For example, an image that has been already trimmed may be received from the orderer. Furthermore, various kinds of image processing such as selection of a tone color may be performed. After performing image processing, the image is synthesized with data about the part as mentioned previously, and a conceptual drawing of a finished product is offered. The invention is not restricted to this scheme. For example, a conceptual drawing of the finished product may be offered after inputting image data or by letting the user to enter character data beforehand and combining the character data with the image data.

In the embodiment described above, the commercial product is a timepiece. The invention is not limited to this. The invention can be applied to a method of accepting an on-line order for any product as long as one or more of its parts are selectable from a plurality of parts of different styles or are decorated with characters or an image.

In accordance with the present invention, when an orderer places an order for a product, data about characters and/or an image used for decoration of at least one of plural parts of the product is accepted on-line. At the request of the orderer based on the data about the characters and/or image, a conceptual drawing of the finished product is offered to the orderer on-line. Therefore, the orderer can easily order a product matching up to his or her image on an on-line basis.

What is claimed is:

1. A method of facilitating on-line orders for finished products having plural components using a server having a part library containing a plurality of part styles for certain ones of the components of each finished product, whereby an orderer is permitted to make selections from the part styles contained in the part library to order a finished product comprising a desired combination of components from the part library, the method comprising the steps of:
causing the server to accept at least one of alphanumerical and image data entered by the orderer on-line to be used for decoration of a component of the finished product; and
transmitting to the orderer on-line a conceptual drawing of the finished product based on the alphanumerical or image data entered by the orderer so that the orderer may see an image of the finished product.

2. A method of facilitating on-line orders according to claim 1; wherein the step of causing the server to accept at least one of alphanumerical and image data includes the step of causing the server to accept character style data including at least one of character font style, character font size and character font color.

3. A method of facilitating on-line orders according to claim 1; wherein the finished product is a timepiece.

4. A method of facilitating on-line orders according to claim 3; wherein the component decorated with the alphanumerical or image data comprises a dial of the timepiece.

5. A method of facilitating the on-line ordering of a product, comprising the steps of:
storing on a server a part library for each of a plurality of components of the product, each component having a plurality of different, individually-selectable styles;
transmitting a file containing the part library to an orderer after a connection is established between the server and a computer operated by the orderer and displaying thereon an image containing the individually-selectable styles of the components so as to permit the consumer to select a style for each component which will be combined to produce the product;
in response to selection of component styles by the orderer, displaying an image of the product on the computer operated by the orderer based on the selected component styles.

6. A method according to claim 5; further comprising the step of using the server to accept at least one of character and image data entered by the orderer for printed on a given component of the product.

7. A method according to claim 6; wherein the step of displaying an image of the product includes displaying an image of the product containing character or image data entered by the orderer displayed on the given component of the product.

8. A method according to claim 6; wherein the at least one of character and image data comprises character data and includes at least one of a font style, a font color, a font tones and a font size of characters to be displayed printed on the given component of the product.

9. A method according to claim 6; wherein the at least one of character and image data comprises image data containing an image transmitted from the computer operated by the orderer to the server, the image to be printed on the given component of the product.

10. A method according to claim 6; wherein the at least one of character and image data comprises image data containing an image selected by the orderer from an image library stored on the server.
